(19) United States
(12) Patent Application Publication
(10) Pub. No.: US 2005/0259174 A1
(43) Pub. Date: Nov. 24, 2005

(54) Solid state imaging device and method for producing the same

(75) Inventors: Tetsushi Nishio, Kyoto-shi (JP); Kouichi Yamauchi, Takatsuki-shi (JP)

Correspondence Address: HAMRE, SCHUMANN, MUELLER & LARSON P.C., P.O. BOX 2902, MINNEAPOLIS, MN, 55402, US

(73) Assignee: Matsushita Electric Industrial Co., Ltd., Kadoma-shi (JP)

(21) Appl. No.: 11/132,598

(22) Filed: May 19, 2005

(30) Foreign Application Priority Data
May 21, 2004 (JP) 2004-152316
Apr. 7, 2005 (JP) 2005-111082

(51) Int. Cl. H04N 5/225

(52) U.S. Cl. 348/340

(57) ABSTRACT

There is provided a solid-state imaging device including: a base that has a through hole penetrating therethrough from a first principal face thereof to a second principal face thereof; a solid-state imaging element whose imaging surface faces an opening on the second principal face side of the through hole and that is fixed to a peripheral region of the opening with a sealing resin; and a translucent plate that is fixed to a peripheral region of an opening on the first principal face side of the through hole with a sealing resin, wherein the peripheral region of at least one of the opening on the first principal face side and the opening on the second principal face side is roughened more than other regions of the base. Thus, a solid-state imaging device that can reduce resin bleeding, while ensuring connection reliability, is provided.

### BACKGROUND OF THE INVENTION

1. Field of the Invention

The present invention relates to solid-state imaging devices and methods for producing the same.

2. Description of the Related Art

In recent years, performance enhancement and miniaturization have been carried out for optical devices and apparatuses using light emitting/receiving elements, and these devices and apparatuses are used in various places, for example, for automated door closing/opening systems and remote controls. Among such optical devices and apparatuses, solid-state imaging devices are used widely in fields such as medical care, industry and information, for example, for electronic devices such as mobile phones, digital still cameras and video cameras. With the recent miniaturization and thickness reduction of the electronic devices, the same requirements increasingly have been placed also on the solid-state imaging devices. In order to fulfill such requirements, JP2002-43554A, for example, has proposed a solid-state imaging device fulfilling the above-described requirements.

FIG. 9 shows a cross-sectional view of a solid-state imaging device 200 proposed in JP2002-43554A. As shown in FIG. 9, a base 32 has a plate-like form having a through hole 17 at the center, and a wiring pattern 33 is formed on its principal face located on the lower side of FIG. 9. A solid-state imaging element 30 is mounted on the wiring pattern 33 via bumps 34 by a flip chip technique. A glass plate 31 is provided on a principal face of the base 32 that is located in the upper side of FIG. 9. A sealing resin 35 and a sealing resin 36 are filled at the periphery of the solid-state imaging element 30 and that of the glass plate 31, respectively, thus sealing light receiving elements 38 of the solid-state imaging element 30. Furthermore, metal balls 37 are provided on the external terminals of the base 32, so that a circuit board (not shown) on which the solid-state imaging device 200 is mounted can be connected electrically to the solid-state imaging device 200, with an appropriate gap kept between the above-described circuit board and the solid-state imaging device 200. It should be noted that a glass-epoxy resin substrate, a ceramic substrate or the like, for example, can be used as the base 32.

Next, a method for producing the solid-state imaging device 200 will be described with reference to FIGS. 10 and 11. First, the base 32 and the solid-state imaging element 30 are aligned such that the light receiving elements 38 face the through hole 17, and thereafter, the solid-state imaging element 30 is mounted on the wiring pattern 33 via the bumps 34 by a flip-chip technique (FIG. 10A). Next, the sealing resin 35 is injected from a dispenser 16 into the gap between the base 32 and the solid-state imaging element 30, in order to achieve a stable electrical connection (FIG. 10B). Then, after the sealing resin 35 has been cured completely, the sealing resin 36 is applied with the dispenser 16 to predetermined positions on a surface of the base 32 that is opposite from a surface thereof on which the solid-state imaging element 30 is mounted (FIG. 11A). Next, the base 32 and the glass plate 31 are aligned, and thereafter the glass plate 31 is mounted on the base 32 via the sealing resin 36 (FIG. 11B). Finally, the metal balls 37 (see FIG. 9) are mounted on the external terminals on the base 32, thus forming the solid-state imaging device 200 shown in FIG. 9.

However, the above-described solid-state imaging device and its production method have a problem in that the position control of a fillet edge 35a (see FIG. 12) formed in a gap between the solid-state imaging element 30 and the base 32, the position control of fillet edges 36a and 36b (see FIG. 12) formed in a gap between the base 32 and the glass plate 31, or the adhesion strength of the solid-state imaging element 30 or the glass plate 31 to the base 32 is dependent on the surface condition of the base 32 or the glass plate 31. This results in a reduction of connection reliability of the flip-chip connection portion due to insufficient wetting of the sealing resin 35, impaired appearance due to resin bleeding (oozing) on the front and back surfaces of the base 32 that is caused, on the contrary, by overwetting of the sealing resin 35 or the sealing resin 36, or connection failure of the metal balls 37 due to resin bleeding into the external terminals that is caused by overwetting of the sealing resin 35, producing a cause of a reduced yield.

A surface roughening treatment such as a plasma treatment or a blasting treatment occasionally is performed for the base 32, in order to stabilize the surface condition of the base 32. However, the wettability of the entire surface of the base 32 increases in this case, so that resin bleeding tends to occur from the fillet edge 35a or the fillet edge 36a, resulting in the possibility of causing the above-described reduction in yield due to impaired appearance, or connection failure of the metal balls 37.

On the other hand, in the case where a surface roughening treatment such as a plasma treatment or a blasting treatment is not performed for the base 32, there is the possibility of reduced connection reliability between the solid-state imaging element 30 and the base 32 due to the surface contamination of the wiring pattern 33, or reduced adhesion strength between the base 32 and the solid-state imaging element 30.

Since the above-described phenomena are in a trade-off relationship, it has been extremely difficult to suppress generation of resin bleeding at the fillet edge, while maintaining a stable electrical connection at the same time.

Furthermore, although the size of the fillet edge 36b of the sealing resin 36 is determined by the application amount of the sealing resin 36 and the surface condition of the glass plate 31, an excessively large fillet edge 36b may be formed at the opening of the through hole 17, due to vibrations generated when mounting the glass plate 31, or deterioration of the surface condition of the glass plate 31. In that case, the incident angle of light 39 (see FIG. 12) reaching the light receiving elements 38 increases, so that there is the possibility of causing missing at the periphery of an output image of the solid-state imaging device 200 or a decrease in the amount of light at the periphery.

### SUMMARY OF THE INVENTION

Therefore, with the foregoing in mind, it is an object of the present invention to provide a solid-state imaging device capable of reducing resin bleeding while maintaining connection reliability, and a method for producing the solid-state imaging device.

A first solid-state imaging device of the present invention includes:
a base that has a through hole penetrating therethrough from a first principal face thereof to a second principal face thereof;
a solid-state imaging element whose imaging surface faces an opening on the second principal face side of the through hole and that is fixed to a peripheral region of the opening with a sealing resin; and
a translucent plate that is fixed to a peripheral region of an opening on the first principal face side of the through hole with a sealing resin,
wherein the peripheral region of at least one of the opening on the first principal face side and the opening on the second principal face side is roughened more than other regions of the base.

A second solid-state imaging device of the present invention includes:
a base that has a through hole penetrating therethrough from a first principal face thereof to a second principal face thereof;
a solid-state imaging element whose imaging surface faces an opening on the second principal face side of the through hole and that is fixed to a peripheral region of the opening with a sealing resin; and
a translucent plate that is fixed to a peripheral region of an opening on the first principal face side of the through hole with a sealing resin,
wherein a peripheral region of the translucent plate that is bonded to the peripheral region of the opening on the first principal face side is roughened more than other regions of the translucent plate.

A first method for producing a solid-state imaging device according to the present invention includes the the steps of:
forming a base that has a through hole penetrating therethrough from a first principal face thereof to a second principal face thereof;
performing a surface roughening treatment for a peripheral region of an opening on the second principal face side of the through hole;
fixing a solid-state imaging element to the peripheral region of the opening on the second principal face side with a sealing resin, with an imaging surface of the solid-state imaging element facing the aforementioned opening; and
fixing a translucent plate to a peripheral region of an opening on the first principal face side of the through hole with a sealing resin.

A second method for producing a solid-state imaging device according to the present invention includes the steps of:
forming a base that has a through hole penetrating therethrough from a first principal face thereof to a second principal face thereof;
performing a surface roughening treatment for a peripheral region of an opening on the first principal face side of the through hole;
fixing a solid-state imaging element to a peripheral region of an opening on the second principal face side of the through hole with a sealing resin, with an imaging surface of the solid-state imaging element facing the aforementioned opening; and
fixing a translucent plate to the peripheral region of the opening on the first principal face side of the through hole with a sealing resin.

A third method for producing a solid-state imaging device according to the present invention includes the steps of:
forming a base that has a through hole penetrating therethrough from a first principal face thereof to a second principal face thereof;
fixing a solid-state imaging element to a peripheral region of an opening on the second principal face side of the through hole with a sealing resin, with an imaging surface of the solid-state imaging element facing the aforementioned opening;
performing a surface roughening treatment for a peripheral region of a translucent plate; and
bonding a peripheral region of an opening on the first principal face side of the through hole to the peripheral region of the translucent plate with a sealing resin.

### BRIEF DESCRIPTION OF THE DRAWINGS

FIG. 1 is a cross-sectional view of a solid-state imaging device according to one embodiment of the present invention.

FIG. 2 is an enlarged view of a cross-section of the flip-chip connection portion in FIG. 1.

FIGS. 3A is a plan view of the solid-state imaging device shown in FIG. 1, as viewed from the glass plate side, and FIG. 3B is a plan view thereof, as viewed from the metal balls side.

FIGS. 4A and 4B are plan views showing an example of a method for producing a base used for the solid-state imaging device shown in FIG. 1.

FIGS. 5A and 5B are cross-sectional views showing an example of the step of mounting metal balls on a base used for the solid-state imaging device shown in FIG. 1.

FIGS. 6A to 6C are cross-sectional views for illustrating an example of a method for producing the solid-state imaging device shown in FIG. 1.

FIGS. 7A and 7B are cross-sectional views for illustrating an example of a method for producing the solid-state imaging device shown in FIG. 1.

FIGS. 8A and 8B are cross-sectional views for illustrating an example of a method for producing the solid-state imaging device shown in FIG. 1.

FIG. 9 is a cross-sectional view of a conventional solid-state imaging device.

FIGS. 10A and 10B are cross-sectional views for illustrating an example of a method for producing the conventional solid-state imaging device.

FIGS. 11A and 11B are cross-sectional views for illustrating an example of a method for producing the conventional solid-state imaging device.

FIG. 12 is an enlarged view of the flip-chip connection portion in FIG. 9.

### DESCRIPTION OF THE PREFERRED EMBODIMENTS

First, the first solid-state imaging device of the present invention will be described. The first solid-state imaging device of the present invention includes: a base that has a through hole; a solid-state imaging element; and a translucent plate. The above-described through hole is formed penetrating from a first principal face of the base to a second principal face of the base. Here, “first principal face of the base” refers to a principal face of the base that is on the side on which the translucent plate is fixed, and “second principal face of the base” refers to a principal face of the base on which the solid-state imaging element is fixed.

As the material for forming the base, it is possible to use, for example, a glass substrate, a glass-epoxy resin substrate or a ceramic substrate. The thickness of the base may be, for example, about 0.7 to 2.5 mm. The opening area of the thorough hole formed in the base may be, for example, about 20 to 100 mm².

The imaging surface of the solid-state imaging element faces the opening on the second principal face side of the thorough hole, and the solid-state imaging element is fixed to the peripheral region of that opening with a sealing resin. Here, “imaging surface” refers to, for example, a surface on which light receiving elements are disposed. Furthermore, the translucent plate is fixed to the peripheral region of the opening on the first principal face side of the through hole with a sealing resin. There is no particular limitation with respect to the material constituting the translucent plate as long as the material can transmit light received by the above-described light receiving elements, and it is possible to use, for example, a glass plate having a thickness of about 0.3 to 0.5 mm. Then, in the first solid-state imaging device of the present invention, the peripheral region of at least one of the opening on the first principal face side and the opening on the second principal face side is roughened more than other regions of the base. Here, “roughened region” refers to a surface region whose surface roughness has been increased relative to that of the untreated state as a result of performing a surface roughening treatment such as a blasting treatment or a plasma treatment. In the embodiment of the present invention described below, as a result of using a mask, some regions in a surface are subjected to a surface roughening treatment, while other regions in the same surface are not, thus forming a partial “roughened region”. The condition of a roughened surface is represented numerically, using the value Ra of “arithmetic mean roughness (in compliance with JIS B0031 and B0601)”, which is determined with a measurement device such as a contact surface roughness meter. In the present invention, it is preferable that the arithmetic mean roughness Ra of a surface that has been subjected to a surface roughening treatment is greater than the arithmetic mean roughness Ra of an untreated surface by at least 0.3 μm.

In the first solid-state imaging device of the present invention, since the peripheral region of at least one of the opening on the first principal face side and the opening on the second principal face side of the base is roughened more than other regions of the base, the wettability with the sealing resin changes at the boundary between the peripheral region and the other regions. Accordingly, it is possible to prevent resin bleeding from the peripheral region (the region with high wettability) to the other regions (the regions with low wettability). Furthermore, with the anchoring effect of the above-described peripheral region, it is possible to improve the connection reliability between the base and the solid-state imaging element, or the adhesion strength between the base and the translucent plate.

Next, the second solid-state imaging device according to the present invention will be described. It should be noted that the description of the same content as in the above-described first solid-state imaging device of the present invention may be omitted in the following.

The second solid-state imaging device of the present invention includes: a base that has a through hole; a solid-state imaging element; and a translucent plate. The above-described through hole is formed penetrating from a first principal face of the base to a second principal face of the base. Then, in the second solid-state imaging device of the present invention, the peripheral region of the translucent plate that is bonded to the peripheral region of the opening on the first principal face side is roughened more than other regions of the translucent plate. Accordingly, it is possible to achieve the same effect as the above-described first solid-state imaging device of the present invention. Furthermore, in order to achieve this effect more reliably, it is preferable that the peripheral region of at least one of the opening on the first principal face side and the opening on the second principal face side is roughened more than other regions of the base, as in the above-described first solid-state imaging device of the present invention.

Next, the first method for producing a solid-state imaging device according to the present invention will be described. The first method for producing a solid-state imaging device according to the present invention is a preferred example of a method for producing the above-described first solid-state imaging device of the present invention. It should be noted that the description of the same content as in the above-described first solid-state imaging device of the present invention may be omitted in the following.

The first method for producing a solid-state imaging device according to the present invention includes the steps of forming a base that has a through hole penetrating therethrough from a first principal face thereof to a second principal face thereof; performing a surface roughening treatment for a peripheral region of an opening on the second principal face side of the through hole; fixing a solid-state imaging element to the peripheral region of the opening on the second principal face side with a sealing resin, with an imaging surface of the solid-state imaging element facing the aforementioned opening; and fixing a translucent plate to a peripheral region of an opening on the first principal face side of the through hole with a sealing resin.

Although the most suitable method for forming the through hole in the base is to form it by molding in a resin sealing step when manufacturing the base, it is also possible to form the through hole with machining means such as punching, or laser processing means, after resin sealing. Preferred examples of the step of performing a surface roughening treatment, the step of fixing a solid-state imaging element with a sealing resin and the step of fixing a translucent plate with a sealing resin will be described later.

Since the first method for producing a solid-state imaging device according to the present invention includes the step of performing a surface roughening treatment for the peripheral region of the opening on the second principal face side of the through hole, it is possible to prevent resin bleeding to the outside of the region that has been subjected to the surface roughening treatment, and to improve the connection reliability between the base and the solid-state imaging element, as described above.

Next, the second method for producing a solid-state imaging device according to the present invention will be described. The second method for producing a solid-state imaging device according to the present invention is another preferred example of a method for producing the above-described first solid-state imaging device of the present invention. It should be noted that the description of the same content as in the above-described first solid-state imaging device and first method for producing a solid-state imaging device according to the present invention may be omitted in the following.

The second method for producing a solid-state imaging device according to the present invention includes the steps of: forming a base that has a through hole penetrating therethrough from a first principal face thereof to a second principal face thereof; performing a surface roughening treatment for a peripheral region of an opening on the first principal face side of the through hole; fixing a solid-state imaging element to a peripheral region of an opening on the second principal face side of the through hole with a sealing resin, with an imaging surface of the solid-state imaging element facing the aforementioned opening; and fixing a translucent plate to the peripheral region of the opening on the first principal face side of the through hole with a sealing resin.

Since the second method for producing a solid-state imaging device according to the present invention includes the step of performing a surface roughening treatment for the peripheral region of the opening on the first principal face side the through hole, it is possible to prevent resin bleeding to the outside of the region that has been subjected to the surface roughening treatment, and to improve the adhesion strength between the base and the translucent plate, as described above.

Next, the third method for producing a solid-state imaging device according to the present invention will be described. The third method for producing a solid-state imaging device according to the present invention is a preferred example of a method for producing the above-described second solid-state imaging device of the present invention. It should be noted that the description of the same content as in the above-described second solid-state imaging device of the present invention and first method for producing a solid-state imaging device according to the present invention may be omitted in the following.

The third method for producing a solid-state imaging device according to the present invention includes the steps of: forming a base that has a through hole penetrating therethrough from a first principal face thereof to a second principal face thereof; fixing a solid-state imaging element to a peripheral region of an opening on the second principal face side of the through hole with a sealing resin, with an imaging surface of the solid-state imaging element facing the aforementioned opening; performing a surface roughening treatment for a peripheral region of a translucent plate; and bonding a peripheral region of an opening on the first principal face side of the through hole to the peripheral region of the translucent plate with a sealing resin.

Since the third method for producing a solid-state imaging device according to the present invention includes the step of performing a surface roughening treatment for the peripheral region of the translucent plate, it is possible to prevent resin bleeding to the outside of the region that has been subjected to the surface roughening treatment, and to improve the adhesion strength between the base and the translucent plate, as described above.

Hereinafter, a solid-state imaging device and a method for producing the solid-state imaging device according to one embodiment of the present invention will be described with reference to the accompanying drawings.

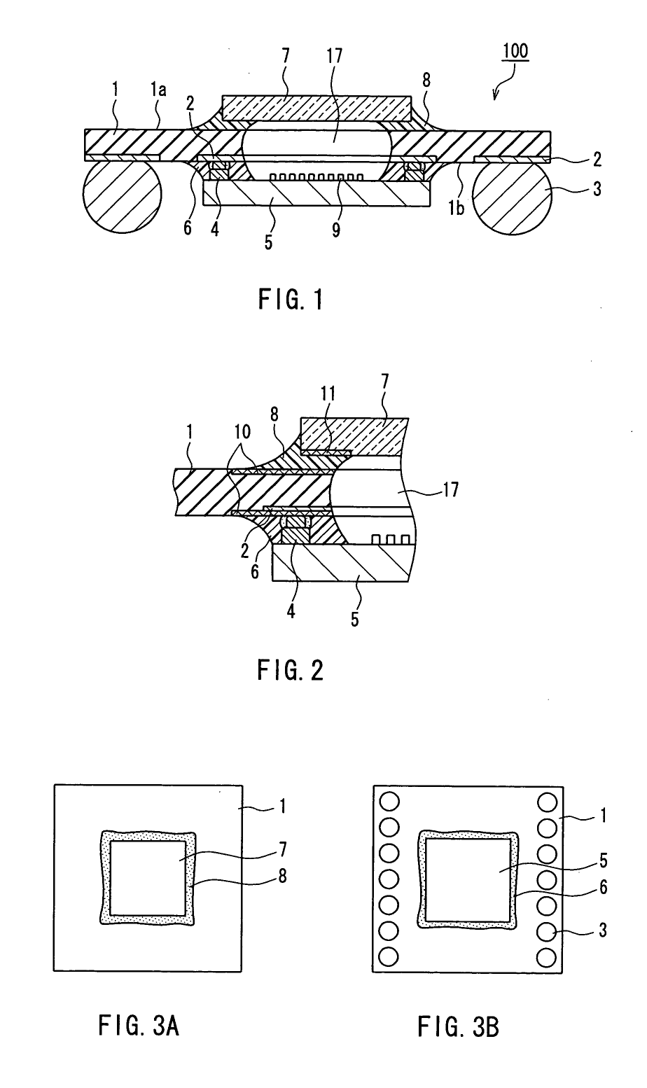

FIG. 1 is a cross-sectional view showing a solid-state imaging device 100 according to one embodiment of the present invention. As shown in FIG. 1, a base 1 made of an insulating material has a plate-like form having a through hole 17 at the center. The through hole 17 is formed penetrating from a first principal face 1a of the base 1 to a second principal face 1b of the base 1. A wiring pattern 2 is formed on the second principal face 1b of the base 1. A solid-state imaging element 5 is mounted on the wiring pattern 2 via bumps 4, e.g. made of gold, by a flip-chip technique. A glass plate 7 is provided on the first principal face 1a of the base 1. A sealing resin 6 and a sealing resin 8 are filled at the peripheral portion of the solid-state imaging element 5 and that of the glass plate 7, respectively, thus sealing light receiving elements 9. Furthermore, metal balls 3 are provided on the external terminals of the base 1, so that a circuit board (not shown) on which the solid-state imaging device 100 is mounted can be connected electrically to the solid-state imaging device 100, with an appropriate gap kept between the above-described circuit board and the solid-state imaging device 100. It should be noted that it is possible to use, for example, eutectic solder balls made of Sn—Pb, Sn—Ag—Cu or the like, as the metal balls 3. It is also possible to use eutectic solder balls formed by coating eutectic solder around cores made of Cu or the like, as the metal balls 3.

FIG. 2 is an enlarged view of a cross-section of the flip-chip connection portion in FIG. 1. As shown in FIG. 2, roughened regions 10 are formed in portions of the base 1 that are in contact with the sealing resin 6 and the sealing resin 8. The roughened regions 10 have been subjected to a surface roughening treatment so as to have a greater roughness than that of other regions of the base 1. In this embodiment, the arithmetic mean roughness Ra of the roughened regions 10 is about 0.5 μm, whereas the arithmetic mean roughness Ra of the regions of the base 1 that have not been subjected to a surface roughening treatment (untreated regions) is about 0.1 μm. As a result of forming the roughened regions 10 in the surface of the base 1, the wettability changes at the boundary between the roughened regions 10 and the untreated regions. Accordingly, even if the sealing resin 6 has bled in the roughened regions 10 with high wettability, for example, at the time of injecting the sealing resin 6, it is possible to stop the resin bleeding at the boundary between the roughened regions 10 and the untreated regions (i.e., the regions with low wettability). Furthermore, with the anchoring effect of the roughened regions 10, it is possible to improve the connection reliability between the base 1 and the solid-state imaging element 5, or the adhesion strength between the base 1 and the glass plate 7.

Further, as shown in FIG. 2, a roughened region 11 is formed in a portion of the glass plate 7 that is in contact with the sealing resin 8. The roughened region 11 is subjected to a surface roughening treatment so as to have a greater roughness than that of other regions of the glass plate 7. Accordingly, it is possible to improve the adhesion strength between the base 1 and the glass plate 7 further, as in the case of the roughened regions 10.

FIG. 3A is a plan view of the solid-state imaging device 100 described with reference to FIG. 1, as viewed from the glass plate 7 side, and FIG. 3B is a plan view thereof, as viewed from the metal balls 3 side. As shown in FIG. 3A, the glass plate 7 is provided at the center of the base 1 so as to cover the through hole 17 (not shown), and the periphery of the glass plate 7 is sealed with the sealing resin 8. Furthermore, as shown in FIG. 3B, the solid-state imaging element 5 is disposed so as to cover the through hole 17 (not shown) at the center of the base 1, and the periphery of the solid-state imaging element 5 is sealed with the sealing resin 6.

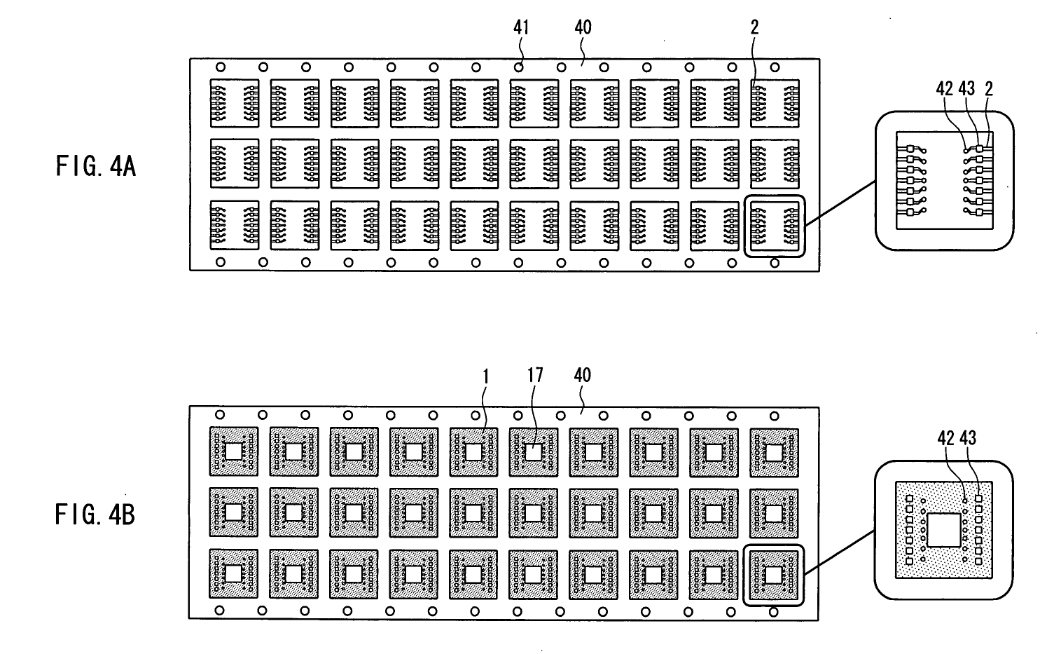

FIGS. 4A and 4B are plan views showing an example of a method for producing the base 1. First, as shown in FIG. 4A, an interposer 40 on which wiring patterns 2 are arranged vertically and horizontally is prepared in order to produce a plurality of bases 1 efficiently. A terminal pad 42 and an external terminal 43 are formed for each of the wiring patterns 2. Additionally, alignment holes 41 are disposed with equal intervals at both ends in the width direction of the interposer 40, in order to increase the yield of the base 1.

As the material for constituting the interposer 40, it is possible to use, for example, a film-like metal foil (e.g., a metal foil obtained by forming a Ni—Au plated film on a Cu foil) or a metal lead frame (e.g., a Fe—Ni material or a Cu alloy material). In this embodiment, a case is described where a metal lead frame is used as the material for constituting the interposer 40. A metal lead frame is produced by molding such as pressing or etching. By processing a metal lead frame such that a portion of the wiring pattern 2 that is other than the terminal pad 42 and the external terminal 43 has a small thickness, it is possible to cover the above-described portion with resin, thus allowing the above-described portion to be hidden from the outside.

Next, a portion on the interposer 40 that will become the bases 1 is coated with a sealant containing an epoxy-based, phenol-based or biphenyl-based insulating resin as the main component such that only the terminal pads 42 and the external terminals 43 are exposed outside (see FIG. 4B), while forming through holes 17. Consequently, a plurality of bases 1 are formed on the interposer 40, as shown in FIG. 4B. Then, although not shown in FIG. 4B, each of the bases 1 is separated individually.

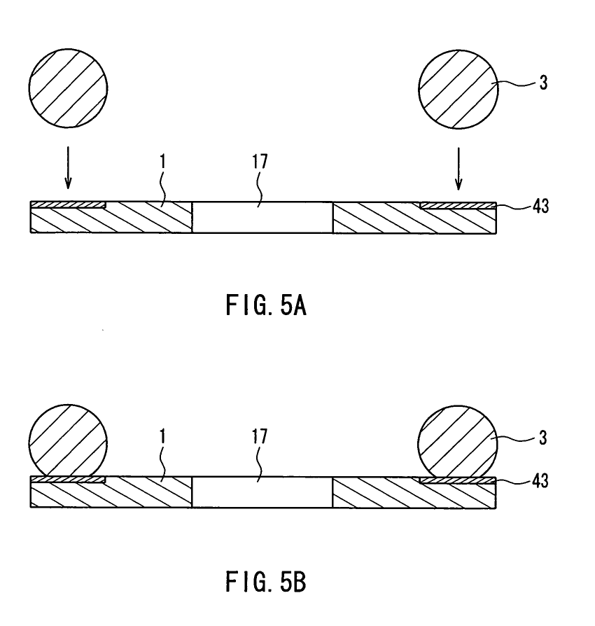

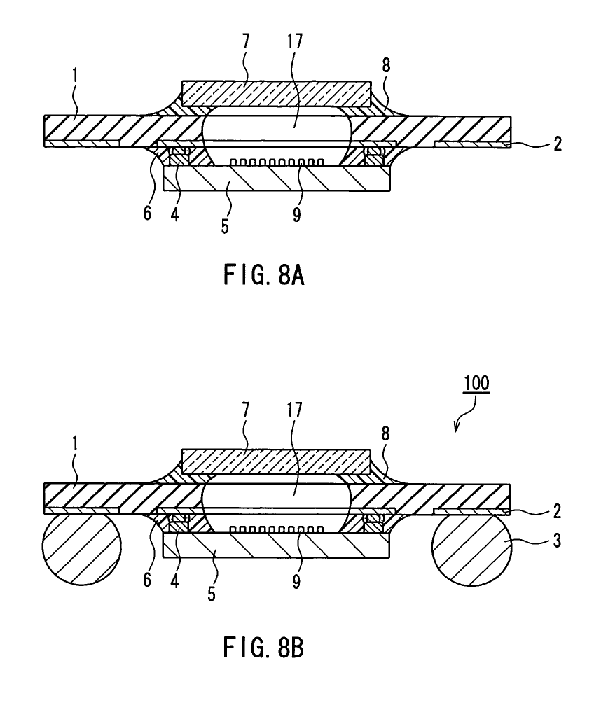

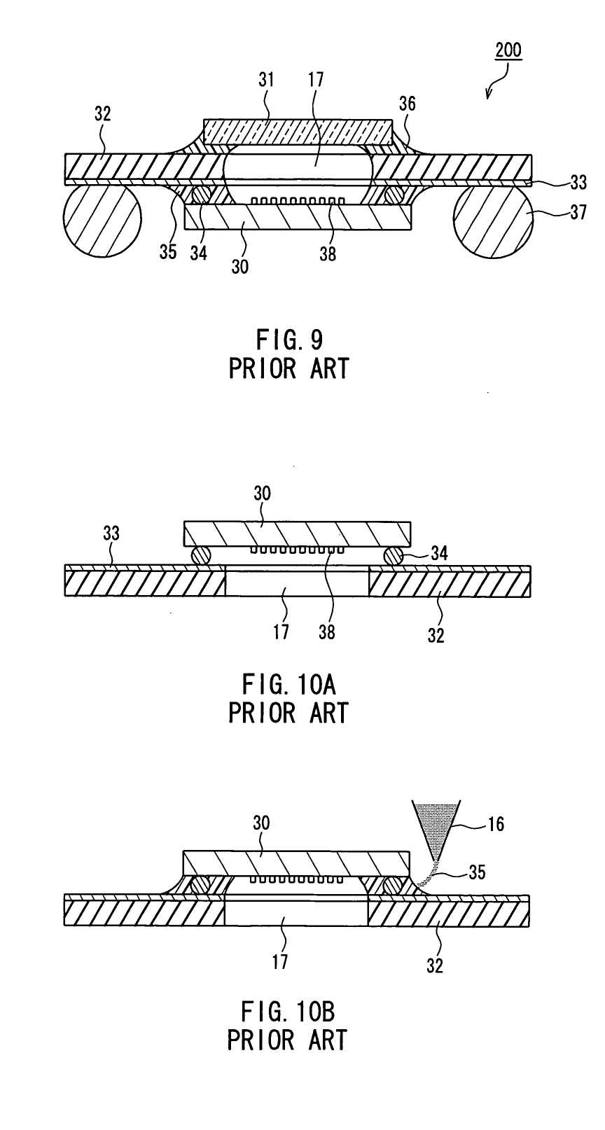

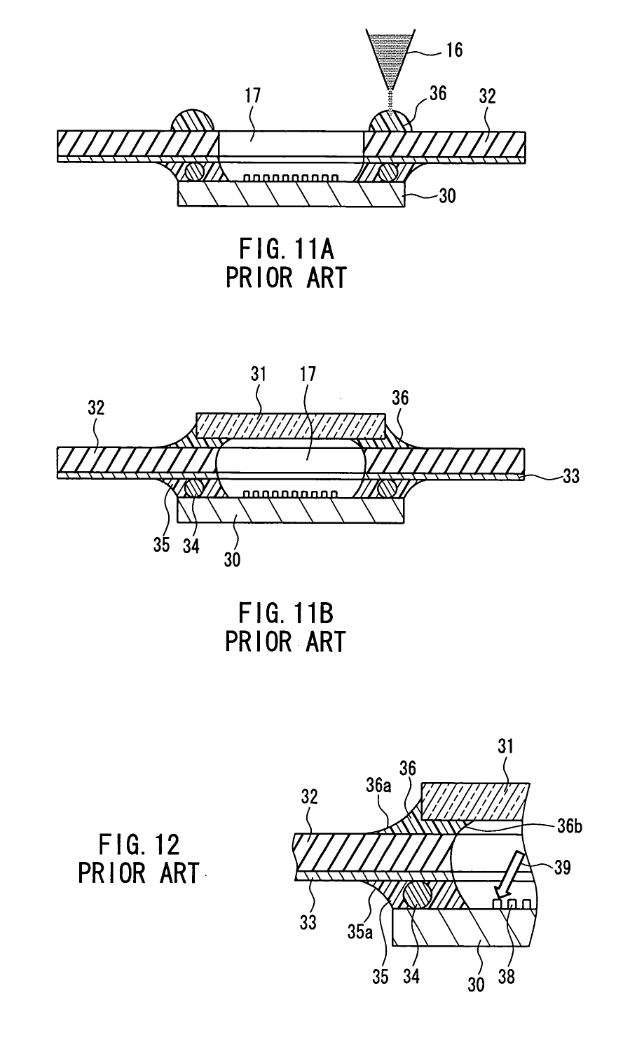

FIGS. 5A and 5B are cross-sectional views showing an example of the step of mounting the metal balls 3 on the base 1. Here, a case is described where solder balls are used as the metal balls 3. As shown in FIGS. 5A and 5B, the external terminals 43 on the base 1 and the metal balls 3 are welded by reflow welding. Although the metal balls 3 may be mounted on the base 1 before the glass plate 7 or the solid-state imaging element 5 is attached as shown in FIGS. 5A and 5B, they may be mounted after the glass plate 7 or the solid-state imaging element 5 is attached as shown in FIG. 8B, which will be described later. Further, the metal balls 3 are not essential components of the present invention. The metal balls 3 are not necessary, for example, in a case where the contact between the bottom surface of the solid-state imaging element 5 and a circuit board (not shown) on which the solid-state imaging device 100 is mounted can be prevented by forming a countersink or a through hole in the circuit board.

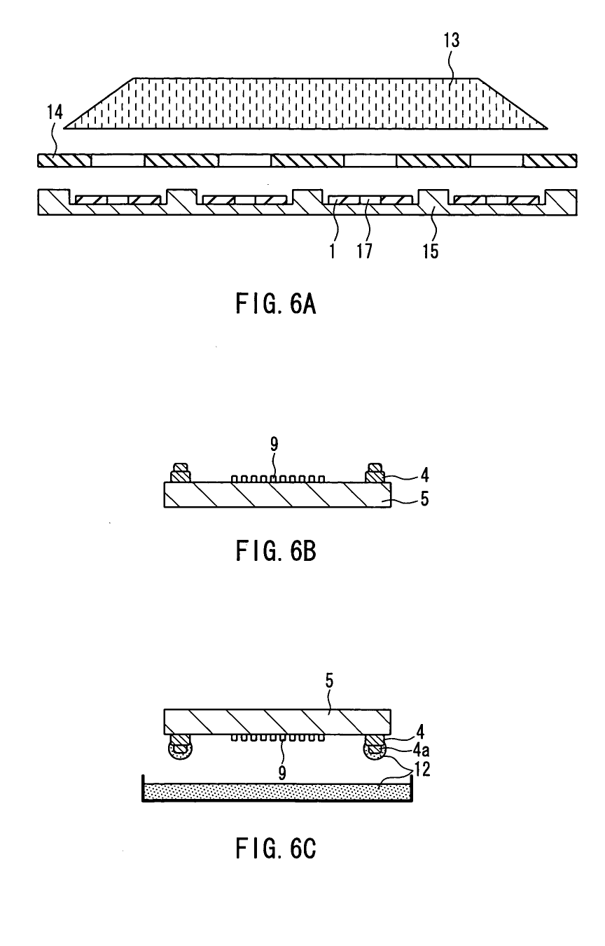

Next, an example of a method for producing the solid-state imaging device 100 will be described with reference to FIGS. 6A to 8B.

First, as shown in FIG. 6A, after a plurality of bases 1 are placed on a tray 15, a surface roughening treatment is performed for the bases 1, with the regions on the bases 1 that are not to be subjected to surface roughening being covered with a mask 14, in order to roughen only predetermined regions (the regions corresponding to the roughened regions 10 shown in FIG. 2). As the mask 14, it is possible to use, for example, a mask made of stainless steel or ceramic, and the thickness of the mask may be about 0.5 to 1.0 mm, for example.

As a specific example of the surface roughening treatment, it is effective to use plasma ashing in which the predetermined regions are irradiated with a plasma gas 13 obtained by converting, for example, oxygen or the like into plasma to remove any contaminant attached to the predetermined regions and a minute portion of the surface layer of the predetermined regions by converting them into a gas such as CO₂ or H₂O, or a blasting treatment in which a slurry containing fine polishing particles is sprayed onto the predetermined regions to remove the above-described contaminant and the like physically. By this surface roughening treatment, it is possible to remove substances (e.g., oils and fats, or dust) that can cause impaired adhesion strength or wettability. Moreover, minute irregularities are formed on the predetermined regions, thus obtaining an anchoring effect. This makes it possible to improve the adhesion strength and the wettability. It should be noted that in this embodiment, this surface roughening treatment is performed for both the front and back sides of the bases 1.

Additionally, in the case of performing the surface roughening treatment by a plasma treatment, the treatment may be performed, for example, for 30 to 70 seconds with an output of the apparatus of 500 W. In the case of performing the surface roughening treatment by a blasting treatment, the treatment may be performed, for example, for 30 to 60 seconds, using alumina particles (the grain size: 800 to 1200 mesh) as the polishing particles. In FIG. 6A, the surface roughening treatment is performed after separating the bases 1 into individual pieces. However, it may be performed in a state where the bases 1 have not been separated.

Next, as shown in FIG. 6B, gold bumps 4 having two-layer projections are formed on electrode pads on the solid-state imaging element 5 that is prepared separately by ball bonding, which uses both ultrasonic wave and thermal compression.

Next, as shown in FIG. 6C, the solid-state imaging element 5 on which the gold bumps 4 are provided is turned over, and the apex portion of the gold bumps 4 is brought into contact with a vessel filled up with a conductive paste 12, and thereby the conductive paste 12 is transferred onto the apex portion of the gold bumps 4. As the conductive paste 12 used in this case, it is possible to use any conductive paste that is used widely in flip chip techniques. For example, it is possible to use a conductive paste in which metal fine particles constituted by palladium, silver or the like having excellent electrical conductivity are mixed with a solvent having viscosity and volatility. Furthermore, in order to prevent short-circuiting between the terminal pads 42 (see FIG. 4B), it is preferable that the amount of the conductive paste 12 attached onto each of the gold bumps 4 is at such a level that projections 4a on the apex side of the gold bumps 4 are covered.

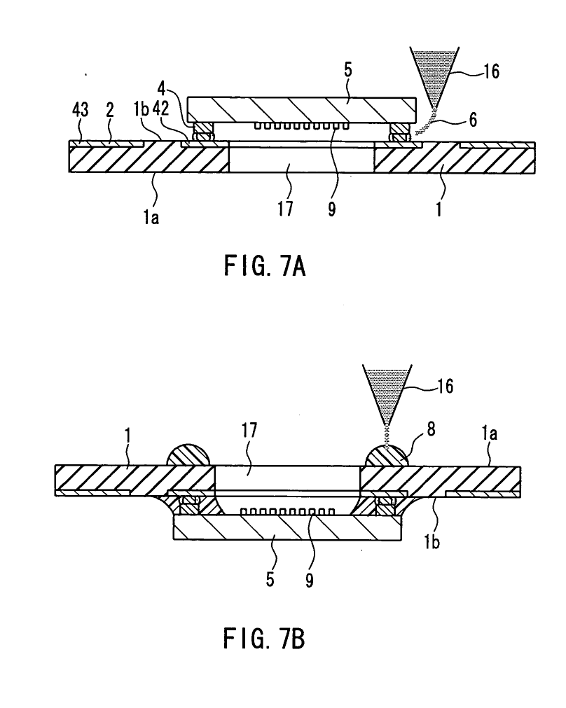

Next, as shown in FIG. 7A, after the solid-state imaging element 5 is placed on the base 1 such that the terminal pads 42 on the base 1 are aligned with the respective gold bumps 4 corresponding thereto, the solvent contained in the conductive paste 12 (see FIG. 6C) is volatized by heating, thus bonding the terminal pads 42 and the gold bumps 4 to each other. Then, the sealing resin 6 is injected into the gap between the solid-state imaging element 5 and the base 1 from a dispenser 16 for ensuring the electrical connection reliability. Here, a portion of the second principal face 1b of the base 1 that is in contact with the sealing resin 6 (the roughened region 10 shown in FIG. 2) has an increased wettability resulting from the surface roughening treatment performed in the previous step, so that the sealing resin 6 swiftly can be filled throughout the gap between the solid-state imaging element 5 and the base 1 (the periphery of the solid-state imaging element 5). Furthermore, as described above, the sealing resin 6 can be prevented from bleeding into the untreated regions because of the presence of the boundary between the roughened region 10 and the untreated regions, so that it is possible, for example, to prevent bleeding components of the sealing resin 6 from reaching the external terminals 43.

Here, if a UV curable resin containing, for example, an epoxy-based prepolymer or the like and a photopolymerization initiator is used as the sealing resin 6 to be injected, and the sealing resin 6 is injected to a location where the peripheral region of the opening on the second principal face 1b side and the solid-state imaging element 5 are bonded, while being irradiated with ultraviolet light through the opening on the first principal face 1a side.

It should be noted that as shown in this embodiment, a flip-chip technique in which connections are established using the gold bumps 4 having two-layer projections and the conductive paste 12 is called the stud bump bonding technique (SBB technique).

Subsequently, after the sealing resin 6 has been cured completely, the sealing resin 8 is applied onto predetermined regions (the roughened regions 10 shown in FIG. 2) on the first principal face 1a of the base 1 with the dispenser 16, as shown in FIG. 7B. Since the roughened regions 10 have been roughened by the surface roughening treatment, they have an improved wettability with the sealing resin 8. Furthermore, it is possible to prevent the sealing resin 8 from bleeding into the untreated regions because of the presence of the boundary between the roughened regions 10 and the untreated regions. It should be noted that as the sealing resin 8, it is possible to use, for example, the same UV curable resin as the above-described example of the sealing resin 6, or a thermosetting resin containing an epoxy resin or the like as the main component.

Next, as shown in FIG. 8A, the glass plate 7 is placed on the base 1 via the sealing resin 8, and the glass plate 7 is fixed to the base 1 by curing the sealing resin 8. Then, the metal balls 3 are mounted onto the wiring patterns 2, using the above-described process shown in FIGS. 5A and 5B. With the method described above, it is possible to obtain the solid-state imaging device 100 shown in FIG. 8B.

In the case of forming the roughened regions 11 on the glass plate 7 as shown in FIG. 2, examples of the surface roughening method include embossing using chemical etching, or engraving using a blasting treatment. By forming the roughened region 11, it is possible to prevent the sealing resin 8 from bleeding into the untreated regions of the glass plate 7, and moreover, it is possible to increase the adhesion strength between the base 1 and the glass plate 7 further. In this case, if the roughened region 11 is formed only in the bonded portion between the glass plate 7 and the base 1, then it is possible to prevent the decrease of the amount of light reaching the light receiving elements 9, thus making it possible to maintain the output characteristics inherent to the solid-state imaging device 100.

Although one embodiment of the present invention has been described above, the present invention is not limited to the above-described embodiment. For example, in the method for producing a solid-state imaging device shown in FIGS. 6A to 8B, the glass plate is fixed to the first principal face of the base after fixing the solid-state imaging element to the second principal face of the base; however, the solid-state imaging element may be fixed to the second principal face of the base after fixing the glass plate to the first principal face of the base.

As described above, with the solid-state imaging device and the method for producing the same according to the present invention, it is possible to provide a solid-state imaging device that can prevent resin bleeding, which may cause impaired appearance or poor image characteristics, while ensuring stable connection reliability.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description. All changes that come within the meaning and range of equivalency of the claims are intended to be embraced therein.

1. A solid-state imaging device comprising:
a base that has a through hole penetrating therethrough from a first principal face thereof to a second principal face thereof;
a solid-state imaging element whose imaging surface faces an opening on the second principal face side of the through hole and that is fixed to a peripheral region of the opening with a sealing resin; and
a translucent plate that is fixed to a peripheral region of an opening on the first principal face side of the through hole with a sealing resin,
wherein the peripheral region of at least one of the opening on the first principal face side and the opening on the second principal face side is roughened more than other regions of the base.

2. A solid-state imaging device comprising:
a base that has a through hole penetrating therethrough from a first principal face thereof to a second principal face thereof;
a solid-state imaging element whose imaging surface faces an opening on the second principal face side of the through hole and that is fixed to a peripheral region of the opening with a sealing resin; and
a translucent plate that is fixed to a peripheral region of an opening on the first principal face side of the through hole with a sealing resin,
wherein a peripheral region of the translucent plate that is bonded to the peripheral region of the opening on the first principal face side is roughened more than other regions of the translucent plate.

3. The solid-state imaging device according to claim 2,
wherein the peripheral region of at least one of the opening on the first principal face side and the opening on the second principal face side is roughened more than other regions of the base.

4. A method for producing a solid-state imaging device, comprising the steps of:
forming a base that has a through hole penetrating therethrough from a first principal face thereof to a second principal face thereof;
performing a surface roughening treatment for a peripheral region of an opening on the second principal face side of the through hole;
fixing a solid-state imaging element to the peripheral region of the opening on the second principal face side with a sealing resin, with an imaging surface of the solid-state imaging element facing said opening; and
fixing a translucent plate to a peripheral region of an opening on the first principal face side of the through hole with a sealing resin.

5. The method for producing a solid-state imaging device according to claim 4,
wherein in the step of performing a surface roughening treatment, a region that is not treated is covered with a mask.

6. The method for producing a solid-state imaging device according to claim 4,
wherein the surface roughening treatment is a plasma treatment.

7. The method for producing a solid-state imaging device according to claim 4,
wherein the surface roughening treatment is a blasting treatment.

8. The method for producing a solid-state imaging device according to claim 4,
wherein in the step of fixing a solid-state imaging element with a sealing resin, the sealing resin is a UV curable resin, and
the sealing resin is injected to a location where the peripheral region of the opening on the second principal face side and the solid-state imaging element are bonded, while being irradiated with ultraviolet light through the opening on the first principal face side.

9. A method for producing a solid-state imaging device, comprising the steps of:
forming a base that has a through hole penetrating therethrough from a first principal face thereof to a second principal face thereof;
performing a surface roughening treatment for a peripheral region of an opening on the first principal face side of the through hole;
fixing a solid-state imaging element to a peripheral region of an opening on the second principal face side of the through hole with a sealing resin, with an imaging surface of the solid-state imaging element facing said opening; and
fixing a translucent plate to the peripheral region of the opening on the first principal face side of the through hole with a sealing resin.

10. The method for producing a solid-state imaging device according to claim 9,
wherein in the step of performing a surface roughening treatment, a region that is not treated is covered with a mask.

11. The method for producing a solid-state imaging device according to claim 9,
wherein the surface roughening treatment is a plasma treatment.

12. The method for producing a solid-state imaging device according to claim 9,
wherein the surface roughening treatment is a blasting treatment.

13. The method for producing a solid-state imaging device according to claim 9,
wherein in the step of fixing a solid-state imaging element with a sealing resin, the sealing resin is a UV curable resin, and
the sealing resin is injected to a location where the peripheral region of the opening on the second principal face side and the solid-state imaging element are bonded, while being irradiated with ultraviolet light through the opening on the first principal face side.

14. A method for producing a solid-state imaging device, comprising the steps of:
forming a base that has a through hole penetrating therethrough from a first principal face thereof to a second principal face thereof;
fixing a solid-state imaging element to a peripheral region of an opening on the second principal face side of the through hole with a sealing resin, with an imaging surface of the solid-state imaging element facing said opening;
performing a surface roughening treatment for a peripheral region of a translucent plate; and
bonding a peripheral region of an opening on the first principal face side of the through hole to the peripheral region of the translucent plate with a sealing resin.

15. The method for producing a solid-state imaging device according to claim 14,
wherein in the step of performing a surface roughening treatment, a region that is not treated is covered with a mask.

16. The method for producing a solid-state imaging device according to claim 14,
wherein the surface roughening treatment is a plasma treatment.

17. The method for producing a solid-state imaging device according to claim 14,
wherein the surface roughening treatment is a blasting treatment.

18. The method for producing a solid-state imaging device according to claim 14,
wherein in the step of fixing a solid-state imaging element with a sealing resin, the sealing resin is a UV curable resin, and
the sealing resin is injected to a location where the peripheral region of the opening on the second principal face side and the solid-state imaging element are bonded, while being irradiated with ultraviolet light through the opening on the first principal face side.
